(19) United States
(12) Patent Application Publication
(10) Pub. No.: US 2025/0073835 A1
(43) Pub. Date: Mar. 6, 2025

(54) Method of Detecting the Current Phase of a Tensioning Curve and Electric Toggle Tensioner

(71) Applicant: Murrelektronik GmbH, Oppenweiler (DE)

(72) Inventors: Marco BOSCH, Oppenweiler (DE); Olaf PREIN, Oppenweiler (DE)

(21) Appl. No.: 18/825,770

(22) Filed: Sep. 5, 2024

(30) Foreign Application Priority Data
Sep. 6, 2023 (EP) 23 195 745.7

(51) Int. Cl. B23Q 3/16; B23Q 3/08; H02K 11/21; H02K 11/27

(52) U.S. Cl. CPC B23Q 3/16; B23Q 3/08; H02K 11/21; H02K 11/27

(57) ABSTRACT

A method of detecting the current phase of the tensioning curve of an electric toggle tensioner, wherein the electric toggle tensioner comprises an electric motor and an evaluation unit. The method comprises at least the following steps: measuring the angle of rotation of the electric motor and the current motor current of the electric motor; evaluating the angle of rotation and the motor current by means of the evaluation unit to obtain an evaluation result; and determining the current phase of the tensioning curve of the electric toggle tensioner based on the evaluation result. An electric toggle tensioner is furthermore described.

### CROSS REFEERENCE TO RELATED APPLICATIONS

This application claims priority to European Patent Application No. 23 195 745.7, filed Sep. 6, 2023, the entire contents of which are hereby expressly incorporated herein by this reference including, without limitation, the specification, claims and abstract, as well as any figures, tables, or drawings thereof.

### TECHNICAL FIELD

Embodiments of the present disclosure relate to a method of detecting the current phase of the tensioning curve of an electric toggle tensioner. Embodiments of the present disclosure also relate to an electric toggle tensioner.

### BACKGROUND

To fix workpieces for processing, tensioners are frequently used, for example mechanical tensioners in the form of quick-action tensioners or toggle tensioners based on the toggle principle.

Pneumatically driven tensioners were developed on the basis of mechanical tensioners, which made it possible to automate the processing of workpieces. Due to the relatively high power losses during operation of the pneumatic tensioners, they were replaced by electrically driven tensioners to increase efficiency.

Among others, electrically driven toggle tensioners are used, i.e. tensioners which are based on the toggle principle and are electrically driven. A toggle lever is moved by an electric drive based on linear actuation. The tensioning force of electric toggle tensioners is thus generated via a lever movement.

Electric toggle tensioners usually have additional mechanisms such as sensors to detect the position of the toggle lever. The position of the toggle lever can also be determined via a magnetic coil and an associated iron core, which can accordingly be regarded as a sensor.

It is an object of the present disclosure to provide an electric toggle tensioner which is cost-effective in production and by means of which the tensioning process can be monitored.

### SUMMARY

According to the present disclosure, the object is achieved by a method of detecting the current phase of the tensioning curve of an electric toggle tensioner. The electric toggle tensioner comprises an electric motor and an evaluation unit. The method comprises at least the following steps:
determining the angle of rotation of the electric motor and the current motor current of the electric motor;
evaluating the angle of rotation and the motor current by means of the evaluation unit to obtain an evaluation result; and
determining the current phase of the tensioning curve of the electric toggle tensioner based on the evaluation result.

The basic idea of the present disclosure is to determine the current phase of the tensioning curve of an electric toggle tensioner (exclusively) on the basis of the angle of rotation of the electric motor and the motor current. This basically eliminates the need for position sensors, which reduces the required installation space and reduces production costs. Furthermore, fewer sensor results need to be recorded and evaluated, which simplifies the evaluation process.

The angle of rotation of the electric motor can be determined, in particular, measured by an angle-of-rotation sensor, for example by an incremental encoder, a potentiometer or a resolver. Alternatively, a servomotor or a stepper motor can also be used as an electric motor so that a specific angular movement is specified, based on which the angle of rotation can be determined. In this respect, determining the angle of rotation can be understood as (actively) measuring the angle of rotation or specifying or forcing a movement which is associated with a specified angle of rotation, so that the angle of rotation can be calculated from the specification.

Furthermore, it is thus also ensured that any manufacturing tolerances have no influence on the position detection of the toggle tensioner, which may be the case with several separately arranged sensors. The tolerance of the sensors is therefore irrelevant for position detection.

With toggle tensioners, it is particularly difficult to detect the position or phase of the tensioning curve due to the operating principle, as explained below.

According to the toggle lever principle, a tensioning arm of the toggle tensioner is far away from the workpiece in an open position. Typically, the workpiece is removed or inserted for processing in this position.

The toggle tensioner can be moved into a holding position in which the workpiece is held via a toggle lever of the toggle tensioner, which comprises two lever elements, for example, by means of the tensioning arm, for example.

To this end, the toggle lever is first moved to its lever dead center, in which the toggle tensioner is tensioned. The force acting on the workpiece, which is also referred to as tensioning force, substantially depends on the force applied to the toggle lever. The force applied to the toggle lever may also be referred to as actuating force.

The toggle lever can then be moved further beyond the lever dead center in the direction of the holding position, the toggle lever being overstretched until the toggle lever reaches a stop. This movement beyond the lever dead center must be initiated, the toggle lever then automatically snapping in the direction of the stop. This is due to the geometry of the toggle lever.

The tensioning force acting on the workpiece is defined, among others, by the geometry of the tensioned workpiece. The maximum possible tensioning force also depends on the geometry or design of the toggle tensioner. The tensioning force is therefore the force which is exerted on the workpiece by the toggle tensioner during tensioning. In contrast thereto, the holding force defines the maximum force which can be exerted on the toggle tensioner without damaging the toggle tensioner. The tensioning force which can be applied to the workpiece is therefore inevitably lower than the holding force of the tensioner. In addition, the tensioning force and the holding force act in opposite directions when opening the toggle tensioner.

In the position moved beyond the dead center of the lever, i.e. the holding position, the toggle tensioner is locked. This means that the toggle tensioner on the tensioning arm cannot be opened, as this would cause the toggle lever to move in the direction of the stop. This locking is therefore also referred to as over-dead-center locking. In other words, a locking effect can be achieved when the toggle lever is overstretched beyond the dead center, as a mechanical stop is present. Even if the actuating force drops, the tensioning force is maintained and the tensioned workpiece cannot release automatically. Forcible opening via the tensioning arm of the toggle tensioner in the holding position therefore leads to damage or destruction of the toggle tensioner.

Based on the evaluation of the detected motor current of the electric motor and the determined angle of rotation of the electric motor, it is therefore possible to determine, among other things, in which of the above-mentioned phases the electric toggle tensioner is located. The detected motor current can be used to determine at least one reference point, from which the position of the toggle tensioner can then be determined based on the determined angle of rotation. The reference point may be, for example, the fully open position of the toggle tensioner or the fully closed position of the toggle tensioner. These positions can be detected via the determined motor current due to the existing stop and the associated increased motor current. By detecting and evaluating the motor current, a torque of the electric motor can be determined so that no torque monitor or similar is required therefor.

The reference point and the determined angle of rotation of the electric motor can therefore be used to determine in which of the above-mentioned phases the electric toggle tensioner is located. In contrast to the prior art, it is therefore not necessary to use one or more position sensors to determine the current phase of the tensioning curve and/or the position of the tensioning arm. Instead, it is provided to use a sensor which detects the motor current, and (optionally) a sensor which detects the angle of rotation, wherein the sensor for the motor current can already be integrated in the electric motor. If the electric motor is a servomotor or a stepper motor, an angle-of-rotation sensor may also be omitted, as already explained. This significantly reduces the number of sensors used and therefore also the manufacturing costs. At the same time, the accuracy can be increased.

In particular, it is possible to determine the current position of a tensioning arm of the toggle tensioner based on the evaluation result using the method. No further sensors are therefore required to determine the position, as a result of which the required installation space can be kept as small as possible. Among other things, the position of the tensioning arm can be deduced if the geometry of the toggle tensioner is known. The position of the tensioning arm is determined exclusively by the angle of rotation of the electric motor and the determined motor current.

If an open position and/or a closed position of the tensioning arm is to be detected, it is sufficient to evaluate only the detected motor current, among other things.

According to one aspect of the present disclosure, the motor current is compared with at least one reference stored in the evaluation unit to obtain a comparison result which corresponds to the evaluation result. In other words, the phase of the tensioning curve is determined based on the detected motor current and the determined angle of rotation of the electric motor by comparing these values with a reference stored in the evaluation unit. As a result, when determining the phase and/or the position, it is already determined whether there are deviations compared to the reference, i.e. compared to the expected result.

Preferably, the reference has a reference curve which comprises a plurality of successive reference points. The reference curve represents a temporal sequence of reference points, i.e. the temporal behavior as a reference. In particular, the reference curve is a theoretically determined reference curve or a previously measured reference curve.

A theoretical reference curve may be provided or simulated by the manufacturer. Other environmental parameters such as temperature can also be taken into account to store the reference curve as accurately as possible. Alternatively, several reference points can be measured, based on which the evaluation unit determines a reference curve, e.g. by interpolation and/or extrapolation.

A further option is to measure a reference curve, i.e. to record a series of measurements of reference data representing the reference curve. The reference curve may be a calibration curve which was performed once or is repeated at predetermined intervals, for example after each commissioning of the electric toggle tensioner, so that possible signs of wear can be taken into account in the reference.

Such a reference run, by means of which the reference curve is obtained, makes it possible, among other things, to compensate for production-related tolerances.

According to one variant, the reference has at least one reference point, in particular wherein the at least one reference point corresponds to the open position and/or the closed position and/or the lever dead center. The reference point may also be a threshold value, i.e. a limit for the motor current. If the reference point is reached or exceeded, it can be concluded that the toggle tensioner has reached its open position, its dead center or its closed position.

In particular, the position of the tensioning arm is determined via the angle of rotation and the reference point. At least one reference point can be stored in the evaluation unit, the position of the tensioning arm being adapted to be determined on this basis and based on the measured angle of rotation. In other words, the position of the tensioning arm can be determined by calculation from the reference point and the measured angle of rotation. If the position of the tensioning arm is known, the phase of the tensioning curve can also be deduced therefrom.

It may be provided that the phases of the tensioning curve comprise a closing movement, tensioning, reaching the dead center, locking, holding, unlocking and releasing. Each of the phases has a specific position and/or a specific motor current, so that it is possible to deduce the phase or position of the tensioning arm from the angle of rotation of the electric motor and the motor current.

These different phases and positions have characteristic motor currents and/or angles of rotation based on reference positions, so that these can be determined accordingly when the measured motor current and/or the measured angle of rotation is/are evaluated.

During the closing movement, the tensioning arm is moved up to a contact with a workpiece so that only a small amount of force needs to be applied during the closing movement. In particular, the force only needs to be high enough to overcome the system-internal friction of the toggle tensioner and accelerate the mass of the tensioning arm. Accordingly, the motor current is low during the closing movement.

In contrast thereto, the motor current increases when the tensioning phase begins and the tensioning arm comes into contact with the workpiece, as additional force must be applied to press down the workpiece. Based on the angle of rotation of the electric motor and a predetermined reference value, it is also possible to calculate the distance traveled until the tensioning process begins, i.e. until the tensioning arm comes into contact with the workpiece.

The dead center is a geometric point of the toggle tensioner so that the dead center can be determined based on the angle of rotation. When the tensioning arm reaches the dead center, the tensioning force begins to build up. The actual force applied can be determined via the motor current.

If the tensioning arm is moved further in the direction of the workpiece after reaching the dead center, i.e. beyond the dead center, locking occurs, namely the so-called over-dead-center locking. The tensioning arm is moved beyond the dead center point up to a stop. Due to its geometry, the toggle tensioner then snaps over, especially up to the stop. This point can also be determined via the motor current. In particular, the force to be applied drops abruptly or even reverses.

During the holding phase, there is no change in position, and the motor current also remains constant at a zero value, as no (more) force has to be applied. Instead, the tensioning force is applied by the toggle tensioner structure.

When unlocking, the toggle lever is approached to slowly move the tensioning arm back towards the dead center so that the tensioning arm no longer presses against the workpiece. The force required to release the tensioning arm, which is (largely) applied by the motor, is of the same order of magnitude as the tensioning force. In addition to the force applied by the motor, spring forces acting against the tensioning force, which originate from the workpiece and/or the tensioning arm, must also be taken into account.

When the toggle tensioner is released, a force counteracting the tensioning force continues to be applied until only the force required to overcome internal system forces, among others friction, of the toggle tensioner and to move the tensioning arm is needed. The determined motor current is therefore very low.

According to one variant, it is provided that faults and wear in the electric toggle tensioner and application errors are deduced from the evaluation of the motor current. The evaluation results in a continuous comparison of the measured motor current with the reference, in particular the reference curve, so that deviations are detected quickly and easily and can be rectified quickly in the event of malfunctions.

Application errors include, for example, incorrect positioning of the workpiece and the use of a wrong workpiece, no workpiece or several workpieces.

In particular, errors occurring in a phase between two characteristic points can also be detected based on the evaluation of the motor current, for example the comparison of the motor current with the reference curve.

For example, the motor current can be used to determine whether a workpiece is present at all. If no workpiece is present, the applied tensioning force or the resulting motor current is significantly below an expected reference value. Even if a workpiece is positioned incorrectly, the motor current or the tensioning force deviates from the expected reference value. Furthermore, it is possible to detect whether two or more workpieces are present. The tensioning force and consequently the motor current is then significantly higher than the expected reference value or the maximum tensioning force. In this case, the motor current can also be higher than the maximum expected motor current even before the dead center is reached.

In principle, the tensioning force applied can be deduced from the detected motor current. Accordingly, no additional sensor is required to determine the applied tensioning force. The geometry of the toggle tensioner can again be taken into account here.

According to one embodiment, the evaluation unit comprises a processor on which a trained artificial intelligence is executed, in particular an algorithm for machine learning, which is used in the evaluation. The artificial intelligence is not only able to determine specific faults based on strong deviations or extreme changes in the determined motor current, but also to register a creeping change in the motor current. Such a creeping change indicates wear of the toggle tensioner, for example. Artificial intelligence can therefore be used to determine anomalies in the workpiece and wear on the toggle tensioner.

Basically, the creeping changes in the motor current can also be detected without artificial intelligence. A trend can be determined to this end, for example for comparison points in the tensioning curve, which may correspond to the reference points. If the comparison points show a trend in one direction, this can be interpreted as an indication of wear.

The artificial intelligence may be provided for simplified detection, as a creeping change can only be determined with a greater effort, in particular with a comparatively high computing effort, as many other effects are also reflected in the motor current, for example the temperature.

The motor current and/or the angle of rotation may serve as input parameters for the artificial intelligence, whereas the position of the tensioning arm and/or the phase of the tensioning curve of the electric toggle tensioner may be provided as output parameters.

The artificial intelligence may have been trained by means of a training method in which a training data set is used which contains input parameters and output parameters to be expected, i.e. the motor current and/or the angle of rotation as input parameters, and an assigned position of the tensioning arm and/or phase of the tensioning curve as output parameters. During training, the artificial intelligence is fed with the input parameters of the training data set, output parameters being output by the artificial intelligence to be trained. These are compared with the output parameters of the training data set to determine a deviation. If the deviation is above a threshold value, the deviation is fed back into the artificial intelligence to be trained, for example, to adjust weighting parameters of the artificial intelligence to be trained. These steps are repeated until the deviation detected is below the threshold value. Once this is achieved, the artificial intelligence is sufficiently trained to be used for evaluation.

The artificial intelligence may be executed on a processor of the toggle tensioner, i.e. locally. Alternatively, the processor may be part of a server structure, so that the artificial intelligence may be a cloud-based software module.

Preferably, at least one reference run is performed to determine a reference. The reference run comprises at least the following steps:
moving the electric toggle tensioner in its closing direction by driving the electric motor by a predetermined angle of rotation in the closing direction;
detecting the motor current; and

=storing a reference based on the detected motor current.

In addition or alternatively to the motor current actually detected, it is also possible to use values derived from the detected motor current, for example extreme values of the motor current, an arithmetic mean of the motor current from several reference runs, a calculated codification of the motor current. The reference can be determined therefrom accordingly.

The method can assume that the angle of rotation is available as an absolute value. The reference run may function as a calibration run and be carried out before each commissioning of the toggle tensioner. Production-related tolerances can thus be largely compensated for by the reference run.

As an alternative to the reference run, a theoretically determined reference can of course also be used. In any case, a reference switch may be dispensed with to simplify the design of the electric toggle tensioner. The end of the movement may be the completely closed or the completely open position, in particular the zero point position, of the toggle tensioner.

According to one aspect, the open position is approached if, when the motor current is detected, it is determined that the motor current remains below a first reference value during the reference run when moving in the closing direction, the stored reference then corresponding to the open position as a reference point. The first reference value corresponds to a reference value for the stop. In this respect, it is determined whether the tensioning arm has been moved to the stop in the direction of the closed position or already comes into contact with a workpiece therebefore, when the electric motor is operated by the predetermined angle of rotation in the closing direction. This is particularly advantageous because it is not necessarily certain whether a workpiece is located on the workpiece carrier when the electric toggle tensioner is started up.

The electric toggle tensioner can be moved to the maximum dead center in the open position and then to the closed position, the motor current being detected again if the motor current exceeds a first reference value when the motor current is detected. If the motor current exceeds the first reference value, the tensioning arm has come into contact with a workpiece or has been moved to the stop in the closing direction. A defined state can be achieved by approaching the dead center in the open position.

It may be provided that, if the motor current exceeds a second reference value when the motor current is detected again, it is determined that the electric toggle tensioner is in the closed position and a workpiece is present, and/or that, if the motor current is below the second reference value when the motor current is detected again, it is determined that the electric toggle tensioner is in the closed position and no workpiece is present. The result is therefore either the electric toggle tensioner is closed and a workpiece is present, or the electric toggle tensioner is closed and no workpiece is present. If a workpiece is present and the electric toggle tensioner is closed, it may be advantageous to also approach the fully open position when opening the toggle tensioner. The second reference value therefore corresponds to a reference value for an inserted workpiece.

According to the present disclosure, the object is furthermore achieved by an electric toggle tensioner having an electric motor, a tensioning arm, at least one sensor and a control and evaluation unit, wherein the control and evaluation unit is set up to carry out the method described above. With regard to the advantages and properties, reference is made to the previous explanations relating to the method, which also apply to the electric toggle tensioner. The at least one sensor may be a sensor which detects the motor current of the electric motor. In addition, an angle-of-rotation sensor may be provided to measure the angle of rotation.

According to the present disclosure, it is therefore precisely not necessary for certain positions of the toggle tensioner to be programmed or manually taught by an operator pressing a button in the respective position. This is due to the fact that the position of the toggle tensioner, i.e. the current phase of the tensioning curve, is determined based on the evaluation result of the angle of rotation and the motor current. There is therefore automation in the present case, as the respective position of the toggle tensioner, i.e. the respectively current phase of the tensioning curve, can be determined automatically by detecting and evaluating the angle of rotation and the motor current.

### BRIEF DESCRIPTION OF THE DRAWINGS

Further features and advantages of the present disclosure will become apparent from the description below and the drawings, to which reference is made and in which:

FIG. 1 shows a schematic representation of an electric toggle tensioner according to the present disclosure;

FIG. 2 shows a flow diagram of the reference run;

FIG. 3 shows a schematic representation of the electric toggle tensioner of FIG. 1 in the zero position;

FIG. 4 shows a schematic representation of the electric toggle tensioner of FIG. 1 at the dead center; and

FIG. 5 shows a schematic representation of the electric toggle tensioner of FIG. 1 in a locked position.

### DETAILED DESCRIPTION

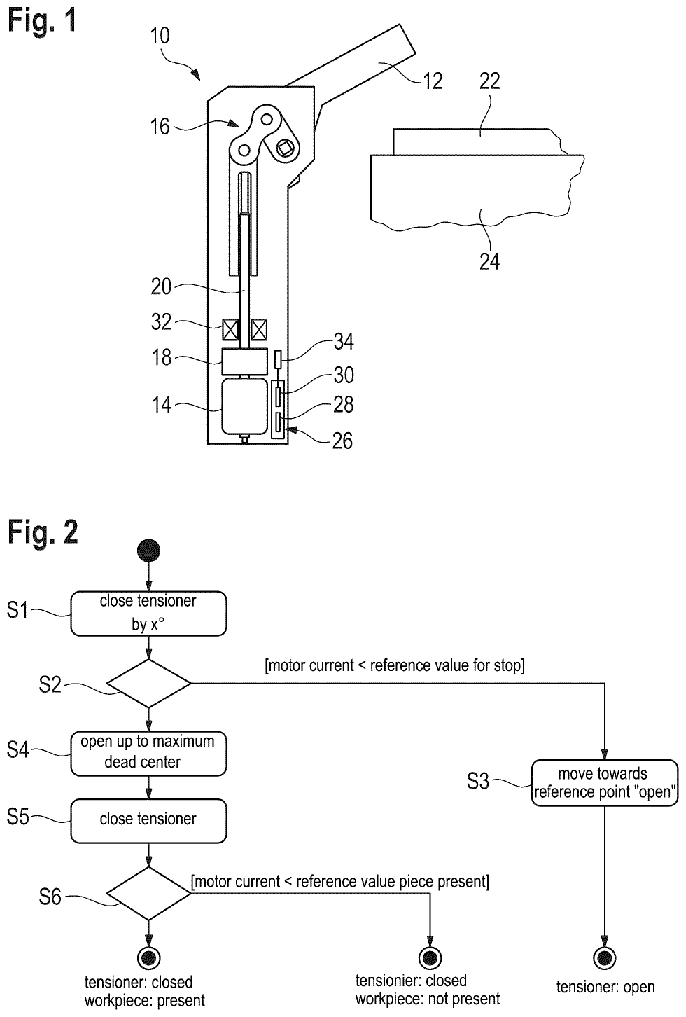

FIG. 1 shows an electric toggle tensioner 10 according to an embodiment of the present disclosure in a half-closed position.

The electric toggle tensioner 10 comprises a tensioning arm 12, an electric motor 14 and a toggle lever 16 which is driven by the electric motor 14 and cooperates with the tensioning arm 12.

The electric motor 14 is connected to a spindle 20, preferably via a transmission 18, the spindle 20 transmitting the movement of the electric motor 14 to the toggle lever 16. As a result, a rotary movement of the electric motor 14 is converted into a linear movement.

The toggle lever 16 is connected to the tensioning arm 12 and can move it away from a workpiece 22, which is placed on a device or a workpiece carrier 24, or move it towards the workpiece 22.

The electric toggle tensioner 10 also comprises a control and evaluation unit 26. The control and evaluation unit 26 thus comprises a control unit 28 and an evaluation unit 30, which can be configured in separate modules or implemented on separate processors, or in a common module or on a common processor.

The control and evaluation unit 26, in particular the evaluation unit 30, can be set up to detect the motor current of the electric motor 14.

Furthermore, in the embodiment shown in FIG. 1, the electric toggle tensioner 10 comprises at least one (optional) sensor 32 for detecting an angle of rotation of the electric motor 14.

The sensor 32, which cooperates with the spindle 20, can be an incremental encoder, an absolute encoder or a resolver, all of which are suitable for determining the angle of rotation of the electric motor 14.

As an alternative to the sensor 32, the electric motor 14 can be realized by a stepper motor or a brushless DC motor, for example in the form of a servomotor, so that a movement or an angle can be forcibly specified. No further sensor is then required to detect the angle of rotation.

The tensioning curve of the electric toggle tensioner 10 comprises a plurality of phases, e.g. a closing movement, tensioning, reaching the dead center, locking, holding, unlocking and releasing.

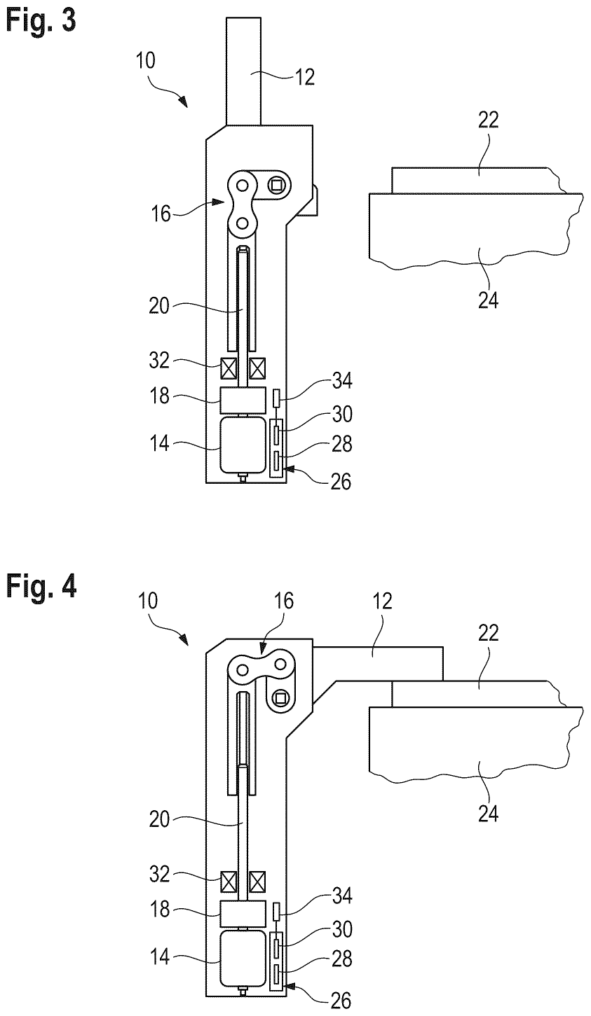

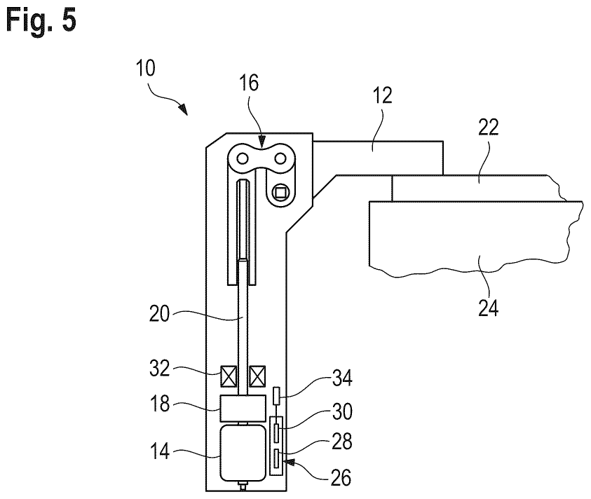

In FIG. 1, the electric toggle tensioner 10 is in a half-closed position, which can correspond to the closing movement or to releasing. The dead center of the toggle tensioner 10 is shown in FIG. 4, while FIG. 5 shows the completely closed position, i.e. the holding phase of the electric toggle tensioner 10. In contrast thereto, FIG. 3 shows the electric toggle tensioner 10 in its zero position, i.e. in the fully open position.

Each of the phases of the tensioning curve has a characteristic angle of rotation and/or motor current of the electric motor 14. Thus, the phase of the tensioning curve and the position of the tensioning arm 12 or the toggle lever 16 can be deduced based on the determined motor current and the determined angle of rotation. A reference point is determined by means of the motor current, from which the phase of the tensioning curve and the position of the tensioning arm 12 or toggle lever 16 can then be determined based on the determined angle of rotation.

For this purpose, an evaluation result can be determined by the evaluation unit 30 and compared with a reference.

Furthermore, the applied tensioning force of the electric toggle tensioner 10 can be deduced from the measured motor current. The tensioning force is proportional to the determined motor current. Consequently, an increase in the motor current corresponds to an increase in the tensioning force, and a decrease in the motor current corresponds to a lower tensioning force.

The individual phases of the tensioning curve are explained below, in particular their relationship to the angle of rotation of the electric motor 14 and the motor current, wherein it is assumed that the electric toggle tensioner 10 is in the open position at the start. In other words, the tensioning curve starts in the zero point position of the electric toggle tensioner 10 shown in FIG. 3, so that a workpiece 22 can be placed on the workpiece carrier 24.

During a closing movement, the tensioning arm 12 moves from the zero point position in the direction of the workpiece 22, which is shown, for example, in FIG. 1.

During the closing movement, the tensioning arm 12 is therefore not yet in contact with the workpiece 22, so that only a force has to be applied to overcome the friction of the toggle tensioner 10 and to ensure the acceleration of the mass of the tensioning arm 12. Accordingly, a low motor current is detected.

As soon as the tensioning arm 12 comes into contact with the workpiece 22, the tensioning force increases. Accordingly, an increase in the motor current is also detected. The angle of rotation can be used to determine the distance traveled by the tensioning arm 12 from the zero point position up to the contact with the workpiece 22.

If the spindle 20 is moved further or the tensioning arm 12 is moved further towards the workpiece 22, the electric toggle tensioner 10 reaches its dead center. This position is shown in FIG. 4. The dead center of the electric toggle tensioner 10 is a geometric position, so that it can be determined particularly well by the angle of rotation. The applied tensioning force can be calculated based on the determined motor current. When setting up the electric toggle tensioner 10, the tensioning force can also be determined at this point, which makes it possible to optimally adjust the electric toggle tensioner 10.

If the spindle 20 is driven further after reaching the dead center, the electric toggle tensioner 10 reaches its locking position. Finally, the toggle lever 16 snaps over, as the spindle 20 is driven beyond the dead center of the toggle lever 16. The electric toggle tensioner 10 reaches the stop which limits the snapping movement of the tensioning arm 12, which is shown in FIG. 5. This point can also be determined particularly well using an angle of rotation, while the motor current provides information about the tensioning force applied.

During the holding phase, there is no change in the motor current or in the angle of rotation, as the tensioning arm 12 is pressed against the stop by the toggle lever 16.

When unlocking, the motor current increases until the dead center is reached. The tensioning arm 12 is therefore moved towards the dead center and then (back) towards the zero point position.

After unlocking, releasing takes place, the motor current decreasing again and the tensioning force further decreasing accordingly until the workpiece 22 is released. Between the point at which the workpiece 22 is released and the zero point position, force only needs to be applied to overcome the internal friction. The motor current required is correspondingly low.

The reference stored in the evaluation unit 30 preferably has a reference curve which includes a plurality of successive reference points, i.e. a time curve of the reference points. The reference curve can be determined theoretically or be a previously measured reference curve.

However, the reference should have at least one reference point which corresponds to the open and/or closed position.

The determination of a reference point is shown schematically in the flow diagram in FIG. 2, to which reference is made below.

Such a reference run is preferably carried out each time the electric toggle tensioner 10 is switched on, as the angle of rotation should be given as an absolute value to determine the position of the electric toggle tensioner 10 and the phase of the tensioning curve.

However, the spindle 20 enables rotations exceeding 360 degrees, so that an angle of rotation over several rotations is meant. A reference point must therefore be determined at least once, for example via the motor current. In particular, if the angle of rotation cannot be stored in the switched-off state, a reference run must be performed each time the toggle tensioner 10 is switched on.

At the start of the reference run, the electric toggle tensioner 10 is driven by the electric motor 14 by a predetermined angle of rotation in the direction of closing in a first step S1. The motor current is detected and compared with a first reference value, which corresponds to a stop, in a second step S2.

If the motor current remains below the first reference value, the tensioning arm 12 has neither come into contact with a workpiece nor been moved to the stop.

Accordingly, the electric toggle tensioner 10 is moved to its zero point position, i.e. to its fully open position, in a third step S3. The zero point position is shown in FIG. 3, wherein the tensioning arm 12, the toggle lever 16 and the spindle 20 are arranged coaxially in the zero point position. Based on the determined motor current and a corresponding reference value, it can be recognized when the tensioning arm 12 has reached the zero point position.

If in step S2 the motor current is greater than the first reference value, the tensioning arm 12 has either come into contact with a workpiece 22 or has been moved to the stop. It is therefore not certain whether a workpiece 22 is arranged on the workpiece carrier 24.

If the determined motor current thus exceeds the first reference value for the stop in step S2, the electric toggle tensioner 10 is opened up to the dead center in a fourth step S4. This ensures that the electric toggle tensioner 10 has a defined position.

In a fifth step S5, the electric toggle tensioner 10 is moved into its locking position, which is shown in FIG. 5. In a further step S6, the motor current is detected again. The detected motor current can then be used to determine whether the electric toggle tensioner 10 is in its holding phase or not. It is therefore determined whether a workpiece 22 is present on the workpiece carrier 24, and whether it is currently tensioned by the electric toggle tensioner 10.

To this end, the detected motor current is compared with a second reference value in step S6 to distinguish whether a workpiece 22 is tensioned or whether the toggle tensioner 10 has been moved to the stop.

If the detected motor current exceeds the second reference value, the toggle tensioner 10 is in the closed position and a workpiece 22 is present. If, on the other hand, the motor current is below the second reference value, the electric toggle tensioner 10 is in the closed position and no workpiece 22 is present.

Once the reference point or the reference curve has been determined, the electric toggle tensioner 10 can be used to tension a workpiece 22 on the workpiece carrier 24.

To determine the current phase of the tensioning curve, the angle of rotation of the electric motor 14 and the motor current are recorded. They are compared by the evaluation unit 30 with the reference, i.e. with the reference value or the reference curve, so that the evaluation unit 30 receives a comparison result which corresponds to the evaluation result.

If the evaluation unit 30 detects an abrupt change in the evaluation result or if the evaluation result deviates significantly from the reference or the comparison result, this indicates a fault in the electric toggle tensioner 10.

When the dead center is reached, it can also be determined that no workpiece 22 is positioned between the tensioning arm 12 and the workpiece carrier 24. If no workpiece 22 is present, the determined motor current is significantly below the expected reference value, as the tensioning force to be applied is lower than if a workpiece 22 is present.

An incorrectly positioned workpiece 22 can also be detected as an error. If a workpiece 22 is positioned incorrectly or if several workpieces 22 are placed on the workpiece carrier 24, a motor current which is greater than the expected reference value is detected. In particular, a motor current which is too high is detected even before the dead center is reached.

In addition to such specific faults, a change in the motor current can also be used to detect other faults, in particular wear. While specific faults are characterized in particular by an abrupt increase in the motor current, wear of the toggle tensioner 10 results in a creeping increase in the motor current over a longer period of time. However, this change is difficult to detect and can only be determined with high computational effort, as other effects such as temperature are reflected in changes in the motor current.

To detect such faults and, in particular, wear, i.e. a creeping change, the evaluation unit 30 comprises a processor 34 on which (trained) artificial intelligence is executed. Preferably, this is a machine learning algorithm used to evaluate the change in motor current.

Alternatively, the artificial intelligence or the machine learning algorithm can also be executed on a server structure, for example as part of a cloud, to which the processor 34 or the evaluation unit 30 has access.

The example systems, methods, and acts described in the examples presented previously are illustrative, and, in alternative examples, certain acts can be performed in a different order, in parallel with one another, omitted entirely, and/or combined between different example examples, and/or certain additional acts can be performed, without departing from the scope and spirit of various examples. Accordingly, such alternative examples are included in the scope of the following claims, which are to be accorded the broadest interpretation so as to encompass such alternate examples.

Although specific examples have been described above in detail, the description is merely for purposes of illustration. It should be appreciated, therefore, that many aspects described above are not intended as required or essential elements unless explicitly stated otherwise.

Modifications of, and equivalent components or acts corresponding to, the disclosed aspects of the examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures

### REFERENCE SIGNS

10 Electric toggle tensioner
12 Tensioning arm
14 Electric motor
16 Toggle lever
18 Transmission
20 Spindle
22 Workpiccc
24 Workpiece carrier
26 Control and evaluation unit
28 Control unit
30 Evaluation unit
32 Sensor
34 Processor

We claim:

1. A method of detecting the current phase of the tensioning curve of an electric toggle tensioner, wherein the electric toggle tensioner comprises an electric motor and an evaluation unit, and wherein at least the following steps are carried out:
measuring the angle of rotation of the electric motor and the current motor current of the electric motor;
evaluating the angle of rotation and the motor current by means of the evaluation unit to obtain an evaluation result; and
determining the current phase of the tensioning curve of the electric toggle tensioner based on the evaluation result.

2. The method according to claim 1, wherein the current position of a tensioning arm of the toggle tensioner is determined based on the evaluation result.

3. The method according to claim 1, wherein the motor current is compared with at least one reference stored in the evaluation unit to obtain a comparison result which corresponds to the evaluation result.

4. The method according to claim 3, wherein the reference has a reference curve which comprises a plurality of successive reference points.

5. The method according to claim 3, wherein the reference has a theoretically determined reference curve or a previously measured reference curve.

6. The method according to claim 3, wherein the reference has at least one reference point.

7. The method according to claim 6, wherein the at least one reference point corresponds to the open position and/or the closed position.

8. The method according to claim 1, wherein the phases of the tensioning curve comprise a closing movement, tensioning, reaching of the dead center, locking, holding, unlocking and releasing.

9. The method according to claim 1, wherein faults and wear of the electric toggle lever tensioner are deduced by evaluating the motor current.

10. The method according to claim 1, wherein it is detected whether a workpiece is present.

11. The method according to claim 1, wherein the applied tensioning force is deduced based on the motor current.

12. The method according to claim 1, wherein the evaluation unit comprises a processor on which a trained artificial intelligence is executed.

13. The method according to claim 1, wherein an algorithm for machine learning, which is used in the evaluation.

14. The method according to claim 1, wherein at least one reference run is performed to determine a reference, wherein the reference run comprises at least the following steps:
moving the electric toggle tensioner in its closing direction by driving the electric motor by a predetermined angle of rotation in the closing direction;
detecting the motor current; and
storing a reference based on the detected motor current.

15. The method according to claim 14, wherein the open position is approached if, when detecting the motor current, it is determined that the motor current remains below a first reference value during the reference run when moving in the closing direction, wherein the stored reference then corresponds to the open position as a reference point.

16. The method according to claim 14, wherein the electric toggle tensioner is moved into the open position up to the maximum dead center and is then moved into the closed position, wherein the motor current is detected again if the motor current exceeds a first reference value during the first detection of the motor current.

17. The method according to claim 16, wherein, if the motor current exceeds a second reference value when the motor current is detected again, it is determined that the electric toggle tensioner is in the closed position and a workpiece is present, and/or in that, if the motor current is below the second reference value when the motor current is detected again, it is determined that the electric toggle tensioner is in the closed position and no workpiece is present.

18. An electric toggle tensioner, comprising an electric motor and a control and evaluation unit, wherein the control and evaluation unit is set up to carry out a method according to claim 1.
